(19) United States
(12) Patent Application Publication
(10) Pub. No.: US 2008/0183961 A1
(43) Pub. Date: Jul. 31, 2008

(54) DISTRIBUTED RAID AND LOCATION INDEPENDENT CACHING SYSTEM

(75) Inventor: Qing Yang, Saunderstown, RI (US)

Correspondence Address: CONNOLLY BOVE LODGE & HUTZ LLP, 1875 EYE STREET, N.W., SUITE 1100, WASHINGTON, DC, 20036, US

(73) Assignee: The Board of Governors for Higher Education, State of Rhode Island and Providence Plantations, Providence, RI (US)

(21) Appl. No.: 12/052,410

(22) Filed: Mar. 20, 2008

Related U.S. Application Data
(62) Division of application No. 11/469,366, filed on Aug. 31, 2006.
Application No. 11/469,366 is a continuation of application No. 10/693,077, filed on Oct. 24, 2003.
Application No. 10/693,077 is a continuation of application No. PCT/US02/14141, filed on May 1, 2002.
(60) Provisional application No. 60/312,471, filed on Aug. 15, 2001.
(60) Provisional application No. 60/287,946, filed on May 1, 2001.

(51) Int. Cl. G06F 12/00

(52) U.S. Cl. 711/113; 711/E12.001

(57) ABSTRACT

An information backup system comprises a first computing system including a first local disk that includes a first disk driver. The first computing system also includes first local RAM, a first network interface that is connected to a computer network and includes a first network driver. A first device driver/bridge responsive to communications from the first network driver and the first disk drive writes data to and reads data from the first local RAM. A second computing system also includes second local RAM and a second network interface that is connected to the computer network and includes a second network driver. A second device driver/bridge responsive to communications from the second network driver and the second disk driver writes data to and reads data from the second local RAM.

### CROSS-REFERENCES TO RELATED APPLICATIONS

This application is a divisional application of and claims priority to U.S. patent application Ser. No. 11/469,366, filed Aug. 31, 2006, which is a continuation of, and claims priority to, U.S. patent application Ser. No. 10/693,077, filed Oct. 24, 2003, which in turn claims priority from provisional application Ser. No. 60/287,946, filed May 1, 2001; and from provisional application Ser. No. 60/312,471, filed Aug. 15, 2001. Each of these applications is hereby incorporated by reference.

This invention was made with government support under Grant Nos. MIP-9714370 and CCR-0073377, awarded by the National Science Foundation. The government has certain rights in this invention.

### BACKGROUND OF THE INVENTION

The invention relates to the field of data processing systems, and in particular to a distributed RAID and location independent caching system.

A company's information assets (data) are critical to the operations of the company. Continuous availability of the data is a necessary. Therefore, backup systems are required to ensure continuous availability of the data in the event of system failure in the primary storage system. The cost in personnel and equipment of recreating lost data can run into hundreds of thousands dollars.

Local hardware replication techniques (e.g., mirrored disks) increase the fault tolerance of a system by keeping a backup copy readily available. To ensure continuous operation even in the presence of catastrophic failures, a backup copy of the primary data is maintained up-to-date at an off-site location. When backup occurs at periodic intervals rather than in real-time, data may be lost (i.e., the data updated since the last backup operation). A problem with conventional remote backup techniques is that they occur at the application program level. In addition, real-lime online remote backup is relatively expensive and inefficient.

A storage area network (SAN) is a dedicated storage network in which systems and intelligent subsystems (e.g., primary and secondary) communicate with each other to control and manage the movement and storage of data from a central point. The foundation of a SAN is the hardware on which it is built. The high cost of hardware/software installation and maintenance makes SANs prohibitively expensive for all but the largest businesses.

A private backup network (PBN) is a network designed exclusively for backup traffic. Data management software is required to operate this network. It consequently increases system resource contention at the application level. The backup is not real-time, thus exposing the business to a risk of data loss. This configuration eliminates all backup traffic from the public network at the cost of installing and maintaining a separate network. Use of PBNs in business is limited due to the high cost.

A third known backup technique is database (DB) built-in backup. The increasing business reliance on databases has created greater demand and interest in backup procedure. Most commercial databases have built-in backup functionality.

However, export/import utilities and offline backup routines are disruptive, since they lock database and associated structures, making the data inaccessible to all users. Because processing must cease in order to create the backup, this method of course does not provide real-time capabilities. The same is true for remote backup strategies, which add additional overhead to DB performance. While not achieving real-time capabilities, the installation of any of these backup schemes is a time consuming and difficult task for the database administrator.

Therefore, there is a need for an improved information processing system.

### BRIEF SUMMARY OF THE INVENTION

Briefly, according to an aspect of the present invention, an information processing system such as a backup system includes a plurality of computing units, which each combines or bridges a disk I/O host bus adapter card and a network interface card of the computing unit to implement a distributed RAID and global caching.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a block diagram illustration of a distributed information processing system.

FIG. 2 is a block diagram illustration of an alternative embodiment distributed information processing system.

FIG. 3 is a table of simulation test results.

FIG. 4 is a plot of a remote memory hit ratio versus the number of system nodes.

FIG. 5 is a plot of average input/output response times versus the number of system nodes.

FIG. 6 is a plot of system throughput.

### DETAILED DESCRIPTION OF THE INVENTION

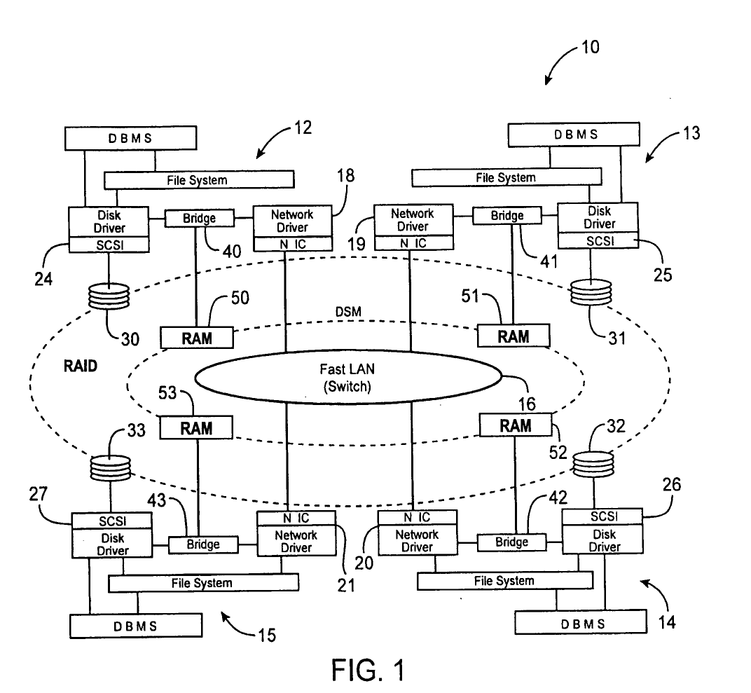

FIG. 1 is a block diagram illustration of an information processing system 10, for example, a backup system. The system 10 includes a plurality of computing devices 12-15 (e.g., personal computers/workstations) that are interconnected via a packet switched data network 16, such as for example a local area network (LAN), a wide area network (WAN), etc. Each of the computing devices 12-15 communicates for example with an associated database management system (DBMS) and file system. In this embodiment, each of the computing devices 12-15 includes an associated network interface card (NIC) 18-21, respectively, that handles input/output (I/O) between the associated computing unit and the network 16. Each computing unit 12-15 also includes a disk input/output host bus adapter card 24-27, respectively, which communicates with a disk drive 30-33 of the associated computing unit. The disk drive may include SCSI drive.

Each computing unit 12-15 also includes a device driver/bridge 40-43, which communicates between the disk driver and the network driver of its associated computing unit. Each computing unit 12-15 also includes local RAM 50-53, respectively, which is partitioned into a first section and a second section. The first section of each RAM is controlled by the local operating system (OS) executing in its associated computing unit. The second section of each RAM is controlled by its associated device driver/bridge 40-43. The second sections of the RAMs 50-53 collectively provide a distributed cache. Each device driver/bridge 40-43 handles communications between their associated NIC 18-21 and second section of RAMs 50-53, respectively, to provide a unified system cache for an underlying RAID system.

To provide a distributed RAID, each of the associated local disks 30-33 is partitioned into at least two disk sections. A first disk section contains the local operating system (OS), data and applications, while a second disk section is configured to be part of a RAID system. That is, the device drivers/bridges 40-43 on each computing device cooperate to provide a distributed RAID, which stores information on the second section of the disks 30-33. Each device driver/bridge 40-43 handles communications between their associated NIC 13-21 and disk driver 24-27, respectively.

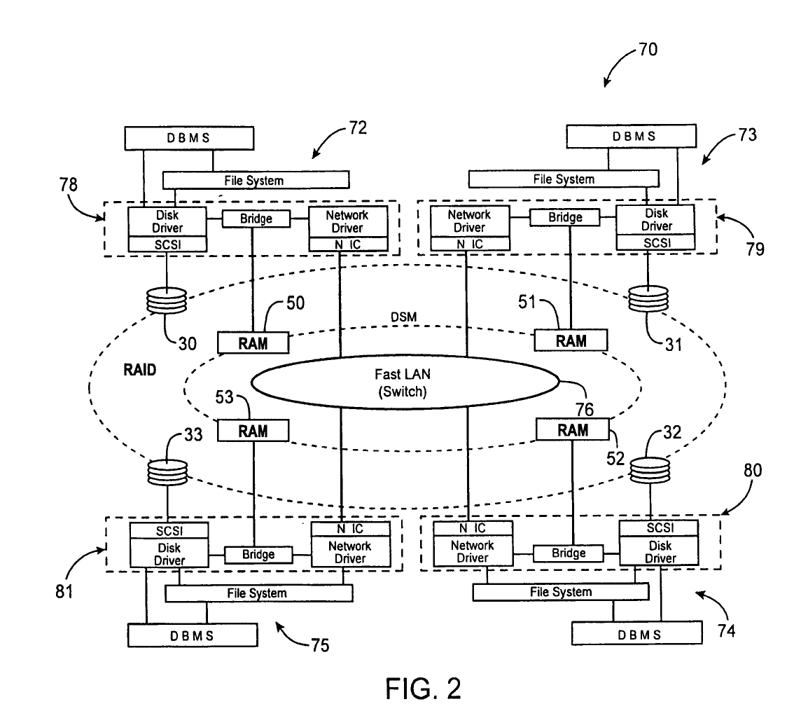

FIG. 2 is a block diagram illustration of an alternative embodiment information processing system 70, for example, a backup system. The embodiment of FIG. 2 is substantially the same as the embodiment of FIG. 1 with the principal exception that the functions of the NIC, the disk driver and the device driver/bridge are integrated onto a single card/integrated circuit with an embedded processor. Referring to FIG. 2, this system includes a plurality of computing devices 72-75 that are interconnected via a packet switched data network 76. Each of the computing devices 72-75 communicates for example with an associated database management system (DBMS) and a file system. In this embodiment, each of the computing devices 72-75 includes an integrated interface card (IIC) 78-81, respectively, that handles input/output (I/O) between the associated computing unit and the network 16, and also I/O between the computing unit and an associated local disk 30-33. Each disk (e.g., 30) together with the disks in other the computing nodes (e.g., disks 31-33) forms a distributed RAID, which appears to a user as a large and reliable logic disk space.

Besides network access and local disk access, each IIC 78-8 1 controls the second partition of its associated RAM 50-53. Significantly, the RAM partitions in the computing nodes together form a large, global, and location independent cache for the RAID and is accessible to any node connected to the network, independent of its physical location.

The system of the present invention combines or bridges the disk I/O host bus adapter card and the NIC to implement distributed RAID and global caching. Specifically, FIG. 1 illustrates an embodiment that bridges the disk I/O host bus adapter card and the NIC, while FIG. 2 illustrates an embodiment that combines disk I/O host bus adapter interface and the NIC.

Advantageously, the system of the present invention allows the computing nodes to work together in parallel to process web requests. The distributed RAID allows parallel operations of disk accesses and provides fault tolerance using parity disks, whereas location independent caches provide cooperative caching to the computing nodes for better I/O performance. The system of the present invention also provides a cost-effective architectural approach since it uses relatively low cost PCs/workstations that are often readily available as existing computing facilities in an organization.

A preliminary performance analysis was performed to look at the effects of bus and network delays on the performance potential of the system. A PCI bus can currently run at about 33-132 MHz with data width of 32 or 64 bits. As a result, the memory bandwidth of PCI based system is BWₙₑₜ=33M*32 bits/sec=132 MB/sec. A Gigabit Ethernet switch with the transfer speed up to 1 Gbps can provide network bandwidth of approximately BWₙₑₜ=100 MB/s. The overhead of network operation including both software and hardware is assumed to be OHₙₑₜ=0.2 ms. As for disks, we consider a typical SCSI disk drive such as a UltraStar 18ES, with a capacity of 9.1 GB, an average seek speed of 7.0 ms, a rotational speed of 7200 RPM, an average latency of 4.17 ms and a transfer rate of 187.2-243.7 Mbps.

Based on the above disk parameters, we can assume the typical bandwidth of the disk to be BW_{dsk}=25 MB/s and the overhead of disk to be OH_{dsk}=1² ms. The following lists other notations and formulae used in the analysis:
B: data block size (8 KB);
N: number of nodes within the system;
Hₗₘ: Local memory hit ratio;
Hᵣₘ: Remote memory hit ratio;
Tₗₘ: Local memory access time (second);
Tᵣₘ: Remote memory access time (second);
T_{raid}: access time from the distributed RAID (second);
T_{pc}: Average I/O response time of traditional PCs with no cooperative caching (second); and
T_{dralic}: Average I/O response time of the system (second).

As a result the following relationships exist:

$$\begin{matrix}{T}_{l m} = \frac{B}{{BW}_{mem}} & EQ . 1 \\ {T}_{rm} \frac{B}{{BW}_{net}} + {OH}_{net} + \frac{B}{{BW}_{dsk}} & EQ . 2 \\ {T}_{raid} = \frac{( N - 1 ) B}{{N}^{′} {BW}_{net}} + {N}^{′} {OH}_{net} + \frac{B}{{NxBW}_{dsk}} + {OH}_{dsk} & EQ . 3 \\ {T}_{pc} = {OH}_{dsk} + \frac{B}{{BW}_{dsk}} & EQ . 4 \\ {T}_{dralic} = {H}_{l m}^{′} {T}_{l m} + {( 1 - {H}_{l m} )}^{′} {H}_{rm}^{′} {T}_{rm} + {( 1 - {H}_{l m} )}^{′} {( 1 - {H}_{rm} )}^{′} {T}_{raid} & EQ . 5\end{matrix}$$

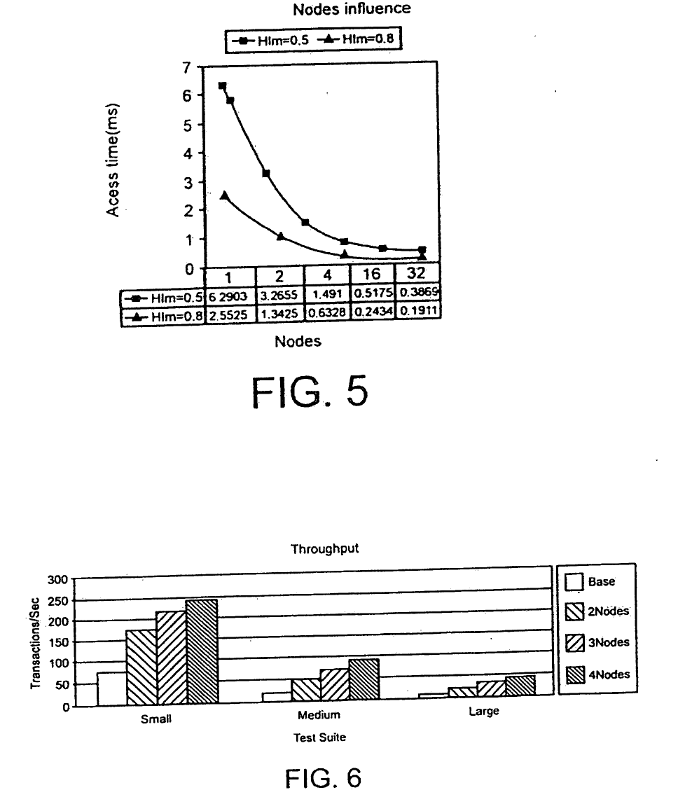

With lack of measured hit ratios of remote caches, a remote hit ratio was assumed to be a logarithm function of number of nodes in the system as shown in FIG. 4. It is reasonable to assume that the remote cache hit ratio increases with the number of nodes because more nodes give larger cooperative cache spaces. The exact hit ratio is not significant here since the hit ratio is used as a changing parameter to observe I/O performance as a function of it. As shown in FIG. 5, even with a hit ratio of 50%, performance is doubled with two nodes. With a remote hit ratio of 80%, a factor of four (4) performance improvement can be obtained with four nodes.

To demonstrate the feasibility and performance potential of the system, a simulation was performed using a program running on every computing node. In the experiments, four computing nodes running Windows NT were connected through a 100 Mbps switch. Four hard drive partitions, one from each node, were combined into a distributed RAID through the system simulation.

PostMark was used as a benchmark to measure the results. PostMark measures performance in terms of transaction rates in the ephemeral small-file regime by creating a large pool of continually changing files. The file pool is of configurable size. In our tests, PostMark was configured in three different ways: (1) small—1000 initial files and 50000 transactions; (2) medium—20000 initial files and 50000 transactions; and (3) large—20000 initial files and 100000 transactions. Other PostMark remained at theft default settings.

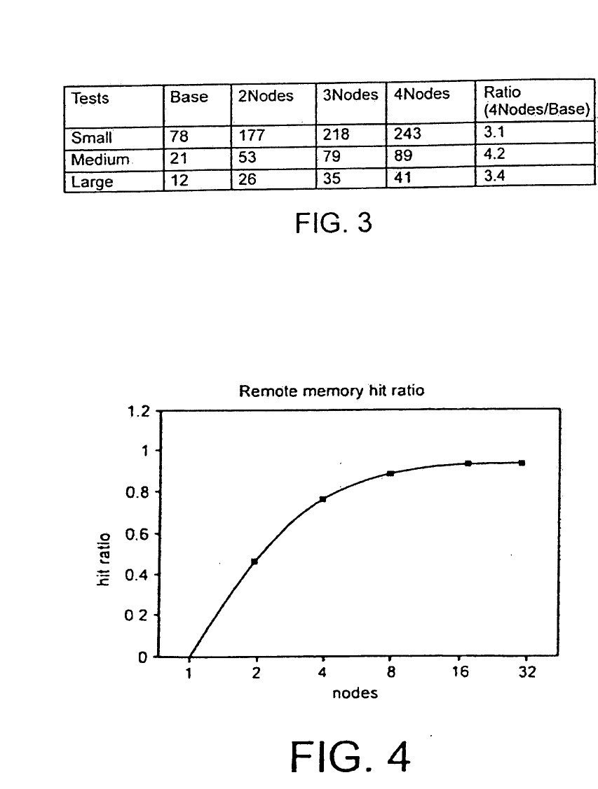

Tests were run with the system configured for two nodes (2 Nodes), three nodes (3Nodes) and four nodes (4Nodes) respectively. These were tested and compared with the results obtained with one node running Windows NT (Base). The results of testing are shown in FIGS. 3 and 6, where larger numbers indicate better performance. With four nodes the performance gain increases to 4.2.

The system of the present invention provides a peer-to-peer direct solution, for example to boost web server performance. The system operates when an actual disk request has come to the system regardless of whether it is a result of a file system miss or a request from a database operation. Advantageously, the system does not require any change to existing operating systems, databases or applications.

Although the present invention has been shown and described with respect to several preferred embodiments thereof, various changes, omissions and additions to the form and detail thereof, may be made therein, without departing from the spirit and scope of the invention.

1. (canceled)

2. A computer to implement distributed memory and storage, comprising:
a network interface configured to communicate with a network;
a random access memory partitioned into at least two sections;
a non-volatile memory partitioned into at least two sections; and
a bridge driver configured to handle communications between the network interface and the non-volatile memory and to control a first section of the random access memory;
wherein the bridge driver is further configured to cooperate with bridge drivers in other computers via the network interface in order to provide to the other computers, regardless of their location, access to a section of the non-volatile memory; and
wherein said first random access memory section is accessible to any of the other computers via the network, regardless of their location, as part of a location independent cache.

3. The device of claim 2, wherein the non-volatile memory comprises a driver.

4. The device of claim 2, wherein the non-volatile memory comprises a disk drive.

5. The device of claim 2, wherein the interface comprises an interface driver.

6. The device of claim 2, wherein the network interface, non-volatile memory, and bridge driver are integrated.

7. The device of claim 6, wherein the network interface, non-volatile memory, and bridge driver are integrated with an embedded processor.

8. The device of claim 2, wherein a second random access memory section is controlled by a local operating system.

9. A method for implementing distributed memory and storage, comprising:
controlling a first section of a partitioned random access memory of each of at least first and second networked computers via bridge drivers respectively associated with the at least first and second networked computers, each of the bridge drivers configured to cooperate to allow the at least first and second networked computers to access each other's first partitioned section via a network, regardless of location of the at least first or second networked computers;
configuring the bridge drivers to respectively provide communications between a network interface and a non-volatile memory associated with each of the at least first and second networked computers; and
configuring the bridge drivers to cooperate to allow the at least first and second networked computers to access selected sections of the other's non-volatile memory, regardless of the locations of the at least first and second networked computers.

10. The method of claim 9, wherein the non-volatile memory further comprises a non-volatile memory driver.

11. The method of claim 9, wherein the non-volatile memory comprises a disk drive.

12. The method of claim 9, wherein the interface comprises an interface driver and the non-volatile memory is a SCSI drive.

13. The method of claim 9, wherein the network interface, non-volatile memory, and bridge driver are integrated.

14. The method of claim 13, wherein the network interface, non-volatile memory, and bridge driver are integrated with an embedded processor.

15. The method of claim 9, wherein the method further comprises controlling a second random access memory section with a local operating system.

16. A method for implementing distributed memory and storage over a network, comprising:
controlling a first section of a partitioned random access memory of a computer via an associated bridge driver, the bridge driver configured to cooperate to allow any node on the network to access the first partitioned section via a network interface of the computer, regardless of the location of the computer or the node;
configuring the bridge driver to communicate via the network interface and to handle communications between the network interface and a drive associated with the computer; and
configuring the bridge driver to cooperate with a bridge driver associated with the node in order to provide access to sections of the computer drive, regardless of the location of the computer or the node.

17. The method of claim 16, wherein the drive associated with the computer comprises a disk drive.

18. The method of claim 17, wherein the drive associated with the computer comprises a SCSI drive.

19. The method of claim 16, wherein an interface in at least one computer comprises an interface driver.

20. The method of claim 23, wherein the network interface, non-volatile memory, and bridge driver are integrated in the computer.

21. The method of claim 20, wherein the method the network interface, non-volatile memory, and bridge driver are integrated with an embedded processor in the computer.

22. The method of claim 16, wherein the method further comprises controlling a second random access memory section with a local operating system in the computer.

23. An apparatus for implementing distributed memory and storage, comprising:
means for communicating with a network;
memory means partitioned into at least two sections, a first of said sections configured to be accessible to other computers via the network, regardless of their locations, as part of a location independent cache;
storage means partitioned into at least two sections; and
means for handling communications between the means for communicating and the storage means; for controlling a first section of the memory means; and for cooperating with other means for handling communications in other computers via the means for communicating in order to provide to the other computers, regardless of their location, access to a section of the storage means.

24. The apparatus of claim 23, wherein the storage means further comprises at least one hard drive.

25. The apparatus of claim 23, wherein the means for communicating, storage means, and means for handling communications are integrated.

26. The apparatus of claim 25, wherein the means for communicating, storage means, and means for handling communications are integrated with embedded processing means.

27. The apparatus of claim 23, further comprising means for controlling a second section of the memory means.
